(19) United States
(12) Patent Application Publication
(10) Pub. No.: US 2005/0007769 A1
(43) Pub. Date: Jan. 13, 2005

(54) Multi-adjustable spotlight with variably positionable handle and variable light intensity

(75) Inventors: Robert Bonzer, Boise, ID (US); Greg Howard, Boise, ID (US)

Correspondence Address: DYKAS, SHAVER & NIPPER, LLP, P.O. BOX 877, 802 WEST BANNOCK STREET, SUITE 405, BOISE, ID, 83701, US

(73) Assignee: Bon-Aire Industries, Inc., Boise, ID (US)

(21) Appl. No.: 10/871,550

(22) Filed: Jun. 18, 2004

Related U.S. Application Data
(60) Provisional application No. 60/479,658, filed on Jun. 18, 2003.

(51) Int. Cl. F21L 2/00; F21L 4/02

(52) U.S. Cl. 362/157

(57) ABSTRACT

A spotlight having pivotable locking handle, a rechargeable battery connected to a light bulb, housed in a housing, including an on/off switch and a variable switch varying the amount of current powering the light bulb thereby providing for a generally infinite adjustment of light intensity within a designated range.

### BACKGROUND OF THE INVENTION

1. Field of the Invention

The present invention generally relates to portable lighting apparatuses and more particularly to portable high intensity spotlights.

2. Background Information

Many different kinds of portable spotlights exist in the prior art. Among these spotlights, some are powered through a wired connection with an automobile outlet such as a 12V “cigarette lighter” or other electrical connection. Other spotlights have a standard 120V alternating current power connection and yet others are operated from direct current batteries. Each of these typical prior art flashlights also has a handle that is typically fixed to a bottom portion of the flashlight. The prior art spotlights are also typically configured to emit only a single intensity of light from the bulb within the device. This is typically a relatively high intensity as spotlights are frequently used to “spot” or locate items that are present in the darkness, usually at a distance.

While at times a very bright light, with a handle positioned beneath the light and powered by a single current source, is appropriate. In other circumstances, the closeness and proximity of a targeted subject makes the use of such a light improper due to the high intensity of light that is emitted. Thus, a single powered light is not appropriate, nor desired for all occasions and various modifications to this single embodiment are desirable. For example, there are times when a light of lesser intensity is desired, or when a different power source is desired, or when the positioning of the handle with regard to the light-emitting portion needs to be varied. The prior art does not afford for these modifications or alternative types of configurations.

Therefore, what is needed is a spotlight that has an adjustable and variable light intensity. What is also needed is a spotlight that has an adjustable and variable handle that can be variously turned so as to allow the handle to be grasped and held in various configurations and orientations with regard to the user. What is also needed is a spotlight that can be powered from various power locations and that utilizes multiple forms of power within the device. What is also needed is a spotlight that maintains a constant floating charge to a light-transmitting element while the source of power to the element is varied to maintain the intensity of emitted light. What is also needed is a spotlight that includes a stand or positioning device that allows the light to be positioned and left in a single desired orientation and position.

Accordingly, it is an object of the present invention to provide a spotlight that has an adjustable and variable light intensity. It is also an object of the present invention to provide a spotlight that has an adjustable and variable handle that can be turned so as to allow the handle to be held and locked in various configurations and orientations with regard to the user. It is another object of the present invention to provide a spotlight that can be powered from various power locations and that utilizes various forms of power within the device. Another object of the invention is to provide a spotlight that maintains a constant floating charge to a light-transmitting element while the source of power to the element is varied to maintain the intensity of the emitted light. Another object of the present invention is to provide a spotlight that includes a stand or positioning device that allows the light to be positioned and left in a single desired orientation and position.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a portable multifunctional flashlight having the ability to be infinitely adjustable to emit light between zero and two million candlepower. The present invention also contains a handle that is pivotable so as to allow the grasping portion and configuration of the invention to be variously embodied according to the necessities of a user. The multifunctional flashlight has a light emanating source that can be powered from a variety of sources including, but not limited to direct 12 volt battery current, direct 12 volt current from an adapter, and a 12 volt power source such as an automobile cigarette lighter.

The light source is contained within a housing, which has a top and a bottom, and a transparent portion that covers and protects the light source. The multifunctional flashlight is equipped with a first control device, which is an infinitely adjustable switch that allows the amount of light being emitted from the light source to be infinitely adjusted within a designated range so as to meet the selected requirements of a designated user. The adjustable switch may be a rotational dial or thumb-wheel switch that is electronically connected to a rheostat, or similar adjustment electronics. This allows a user in an area, such as a campground, to adjust the intensity of light emitted by increasing or decreasing the output as needed.

The multifunctional flashlight is further equipped with a second control device which is located within the housing. The second control device is an electrical control device that is configured to transform incoming electrical current so as to produce and maintain an appropriate charge and voltage level supply to the light source. In one preferred embodiment, the second control device is a combination of interactive, capacitive, and inductive banks that maintain a steady voltage and current, despite ripples or spikes in the input voltage or current. This may be done through a variety of devices including mechanical and electrical switching as well as various forms and types of process controllers.

The multifunctional flashlight has the ability to accept and recharge an internal rechargeable battery. In the preferred embodiment, this is a lead acid battery. However, it is to be understood that depending upon the necessities of the user and the various circumstances surrounding the configuration and intended use of the light, that other types of batteries including nickel-cadmium, nickel-metal hydride, lithium-ion, zinc-air, silver-zinc, or metal-chloride batteries may be utilized based upon the desired voltage and recharging characteristics. The flashlight also has the ability to accept power inputs from various sources and transfer this power at the appropriate level to the light source. The present invention has a port, which is configured to receive either a 12-volt direct current or 110-volt alternating current through an adapter. The second control device also has the ability to divide the power input so as to provide adequate power to the light emanating source 14 while also charging the internal battery so as to maintain an appropriate charge level therein. The secondary control means also have the ability to stop input into the battery so as to prevent overcharging of the battery once the desired charge level has been achieved. This allows the utilization of the multifunctional flashlight 10, either with a cord connected to a power source or without the cord, when the device's battery is charged.

The multifunctional flashlight 10 has a handle 18 that is adjustable to allow the multifunctional flashlight to be held in a first lantern type of position or in a second pistol-type spotlighting position. In addition, the handle may be turned, locked, and held in an infinite number of positions between the first position and the second position. In the preferred embodiment, the handle is rotatably connected to the multifunctional flashlight housing or body allowing it to rotate specifically between the two primary positions mentioned above. Additionally, a locking mechanism allows the handle to be locked into either of the two positions or an infinite number of alternative configurations between the two specific use positions mentioned above.

The lantern position is a traditional flashlight or lantern holding position. The lantern position allows a user to hold the multifunctional flashlight with an arm extended downward and a hand gripping the handle from above, much the same as a user might grip the handle of a brief case. The pistol-type position is a more active style grip that can be used for more actively and accurately controlling the output of the multifunctional flashlight. The pistol style handle position may be preferable when focusing the output of the multifunctional flashlight on a very specific object or when looking over obstacles. This varying configuration of the handle is accomplished by varying and adjusting the handle and the locking handle in a desired position by varying the configuration of the locking portion of the device. The multifunctional flashlight handle is pivotally connected to the multifunctional flashlight housing or body.

The multifunctional flashlight 10 further comprises a support stand 20 which are positioned beneath the multifunctional flashlight 10. While this style of support stand is shown in the instant invention, it is to be distinctly understood that the invention is not limited thereto but may be variously embodied to include a variety of other features, including multiple feet. The support stand 20 allows the multifunctional flashlight 10 to be oriented or positioned in order to illuminate a specific object. In addition, at least one foot may be positioned near the rear portion of the flashlight so as to suspend the light off of a flat surface and to facilitate the pivoting and orientation of the light. The feet 24 may also prevent the flashlight from rolling over or moving when positioned or set on the ground. In one embodiment, the feet 24 are hingedly mounted to the housing allowing the feet to be fully extended or adjusted for the required orientation of the multifunctional flashlight 10.

The purpose of the foregoing abstract is to enable the United States Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measure by the claims, nor is it intended to be limiting as to the scope of the invention in any way.

Still other objects and advantages of the present invention will become readily apparent to those skilled in this art from the following detailed description wherein we have shown and described only the preferred embodiment of the invention, simply by way of illustration of the best mode contemplated by carrying out our invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective side view of a preferred embodiment of the present invention.

FIG. 2 is a top view of the present invention with the handle in a first position.

FIG. 3 is a bottom view of the present invention.

FIG. 4 is a side view of the present invention showing the stand folded inward.

FIG. 5 is a side view of the preferred embodiment of the invention with the handle in a first position, and the stand extended.

FIG. 6 is a side view of the preferred embodiment of the invention with the handle in a second position and the stand folded.

### DESCRIPTION OF THE PREFERRED EMBODIMENT

While the invention is susceptible to various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

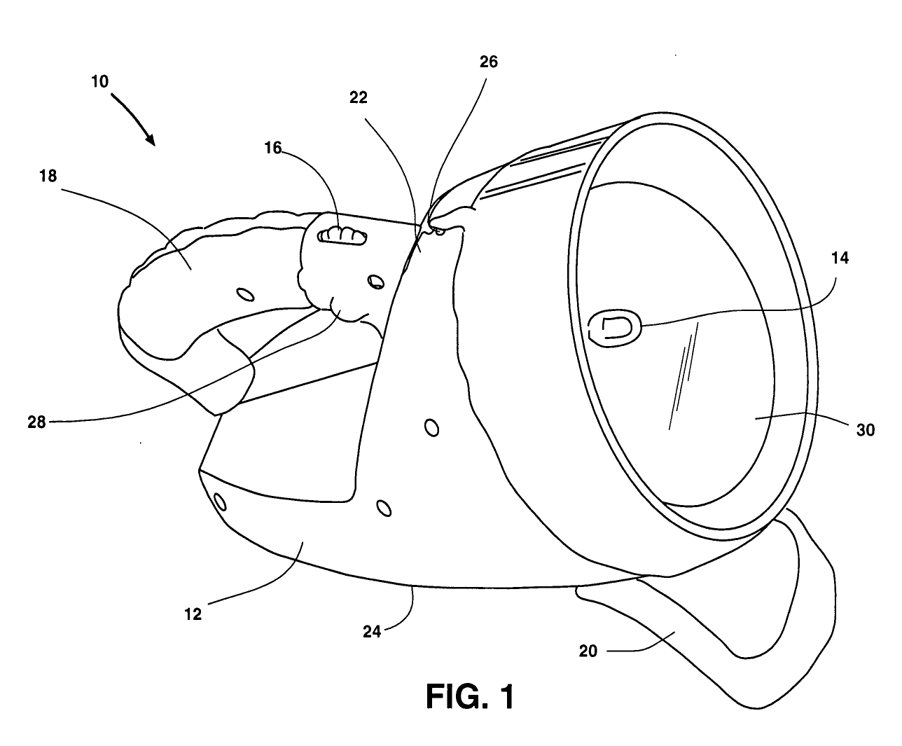

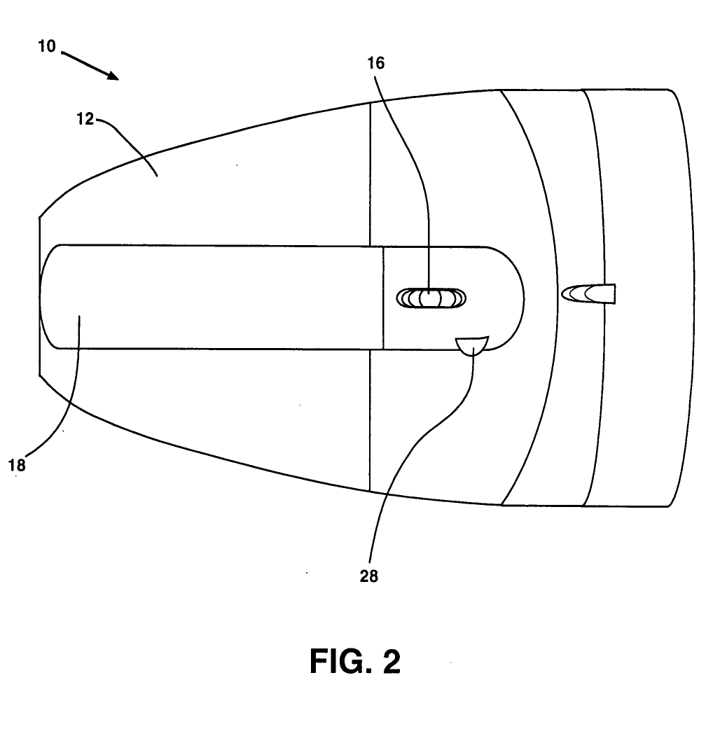

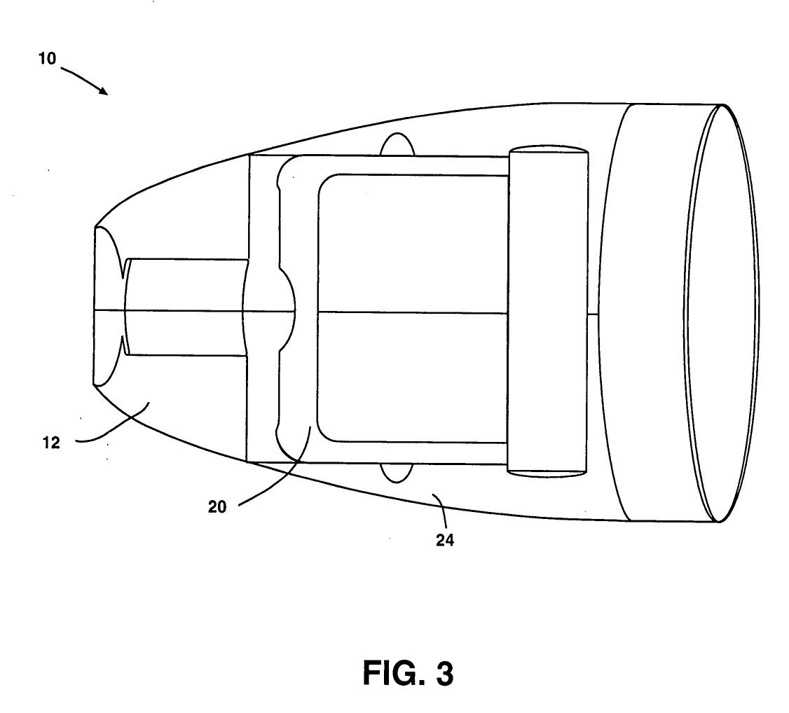

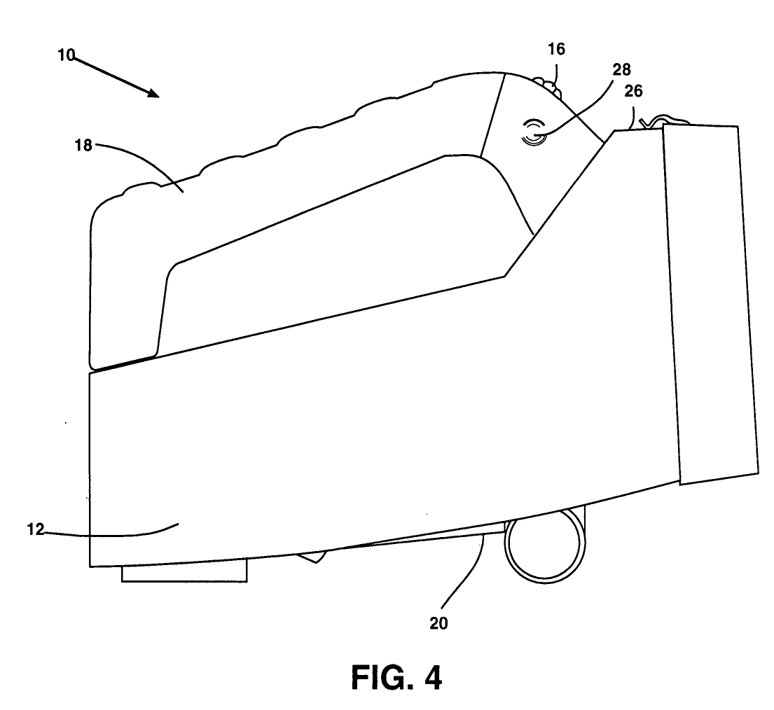

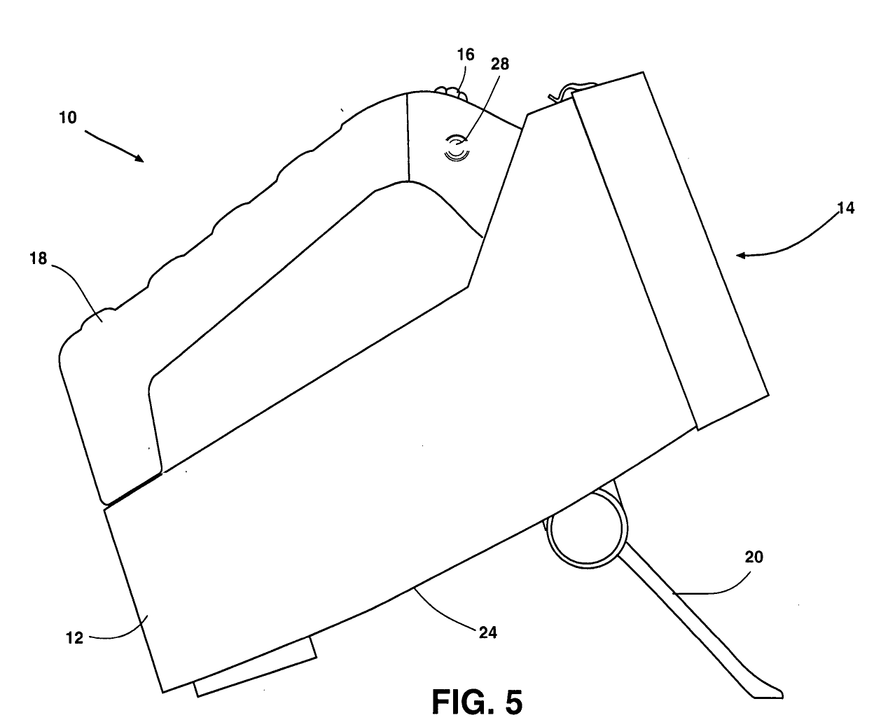

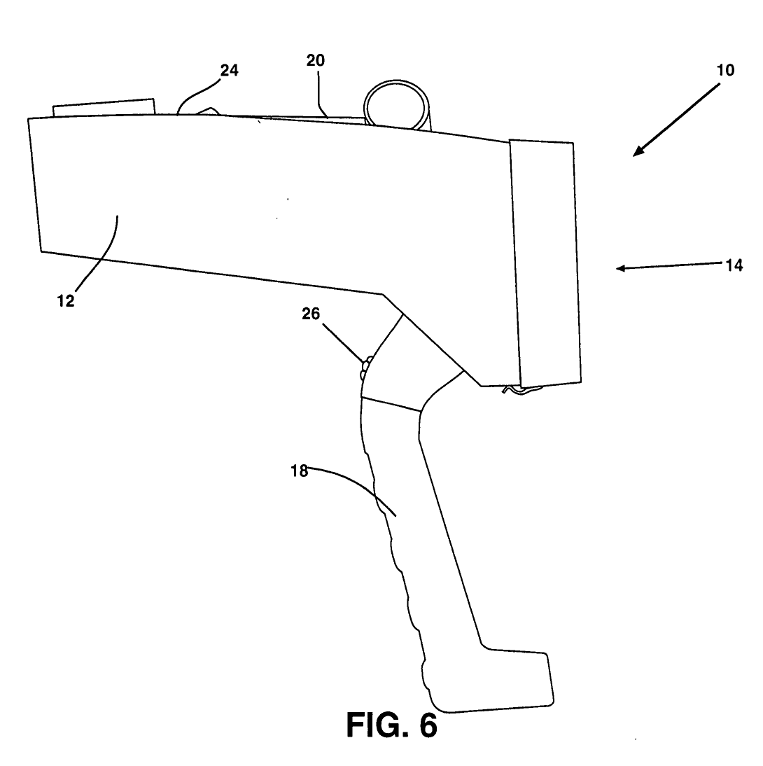

FIGS. 1-6 show various views of the preferred embodiment of the present invention. While this embodiment is shown, it is to be distinctly understood that the invention is not limited to this distinct embodiment, but that it may be variously embodied to include the various novel features and combinations that are set forth in the following claims. Various embodiments of the present invention may have some or all of the features discussed in this application.

Referring now to FIGS. 1-6, a preferred first embodiment of the present invention is shown. The present invention is a portable multifunctional flashlight 10 having the ability to be infinitely adjustable to emit light between zero and two million candlepower. The multifunctional flashlight 10 is comprised of a light emanating source 14 hereinafter referred to as a light source, which is configured to be powered from a variety of sources including, but not limited to a direct 12 volt battery current, direct 12 volt current from an adapter, and a 12 volt power source, such as an automobile cigarette lighter. In the preferred embodiment, the light source is a 100-watt bulb, while in other embodiments, the light source may be multiple light emitting diodes, fluorescent, or halogen lights or other sources. The light source 12 is contained within a housing 12, which has a top 22 and a bottom 24. The housing 12 has a transparent portion 30, which covers and protects the light source 14.

The multifunctional flashlight 10 is equipped with a first control device 14, which is an infinitely adjustable switch 16, which allows the amount of light being emitted from the light source 14 to be infinitely adjusted within a designated range so as to meet the selected requirements of a designated user. This allows a user in an area, such as a campground, to adjust the intensity of light emitted by increasing or decreasing the output as needed. In the preferred embodiment, this first control device 16 is a rheostat switch. A rheostat, as herein defined, is an electronic device that varies the amount of a current passing through it to complete a circuit. As a result, when the resistance of a rheostat is increased, the output of the light source 14 decreases. The adjustable switch 16 may be a rotational, dial or thumb-wheel switch that is electronically connected to a rheostat or similar adjustment electronics. In the preferred embodiment, this infinitely adjustable switch 16 is located in the handle portion 18 of the flashlight. The physical form of the switch can also be variously configured to meet the needs of the user; these various forms include rotational, dial, and thumb-wheel switches.

The multifunctional flashlight 10 is further equipped with a second control device which is located within the housing 12. The second control device is an electrical control device that is configured to transform incoming electrical current so as to produce and maintain an appropriate charge and voltage level supply to the light source 14. In one preferred embodiment, the second control device is a combination of interactive capacitive and inductive banks that maintain a steady voltage and current despite ripples or spikes in the input voltage or current. This may be done through a variety of devices including mechanical and electrical switching as well as various forms and types of process controllers.

The multifunctional flashlight 10 has the ability to accept and recharge an internal rechargeable battery 34. In the preferred embodiment, this is a lead acid battery. However, it is to be understood that depending upon the necessities of the user and the various circumstances surrounding the configuration and intended use of the light 10, that other types of batteries including nickel-cadmium, nickel-metal hydride, lithium-ion, zinc-air, silver-zinc, or metal-chloride batteries may be utilized based upon the desired voltage and recharging characteristics. The flashlight also has the ability to accept power inputs from various sources and transfer this power at the appropriate level to the to light source. The present invention has a port 26, which is configured to receive either a 12-volt direct current or 110-volt alternating current through an adapter. Other types of power conversion devices are also considered within the scope of the invention and the enumeration of these preferred embodiments in this description and is not to be considered an express limitation. The second control device 32 also has the ability to divide the power input so as to provide adequate power to the light emanating source 14 while also charging the internal battery so as to maintain an appropriate charge level therein. The secondary control means also have the ability to stop input into the battery so as to prevent overcharging of the battery once the desired charge level has been achieved. This allows the utilization of the multifunctional flashlight 10, either with a cord connected to a power source or without the cord when the device's battery is charged.

The present invention has an inlet cord-receiving port 26 that is configured to connect with an adapter to recharge the battery of the device. In one embodiment of the invention, one port 26 is provided for a direct current (DC) connection and a separate port is provided for an alternating current (AC) connection, however, it is to be understood that in some embodiments of the invention, the function of both the AC connection and the DC connection may be combined into a single port 26. In the preferred embodiment, this port is covered by a flexible portion of the housing.

The multifunctional flashlight 10 has a handle 18 that is adjustable to allow the multifunctional flashlight 10 to be held in a first lantern type of position or in a second pistol-type spotlighting position. In addition, the handle 18 may be turned, locked, and held in an infinite number of positions between the first position and the second position. In the preferred embodiment, the handle 18 is rotatably connected to the multifunctional flashlight 10 housing or body allowing it to rotate specifically between the two primary positions mentioned above. Additionally, a locking mechanism 28 allows the handle 18 to be locked into either of the two positions or an infinite number of alternative configurations between the two specific use positions mentioned above.

The lantern position is a traditional flashlight or lantern holding position. The lantern position allows a user to hold the multifunctional flashlight 10 with an arm extended downward and a hand gripping the handle 18 from above, much the same as a user might grip the handle 18 of a brief case. The pistol-type position is a more active style grip that can be used for more actively and accurately controlling the output of the multifunctional flashlight 10. The pistol style handle 18 position may be preferable when focusing the output of the multifunctional flashlight 10 on a very specific object or when looking over obstacles. This varying configuration of the handle 18 is accomplished by varying and adjusting the handle 18 and the locking handle 18 in a desired position by varying the configuration of the locking portion of the device. The multifunctional flashlight 10 handle 18 is pivotally connected to the multifunctional flashlight 10 housing or body. In the preferred embodiment, the infinitely adjustable switch 16 is a rotating thumb switch located on the handle, which allows easy one-handed adjustment of the light output.

The multifunctional flashlight 10 further comprises a support stand 20 which are positioned beneath the multifunctional flashlight 10. While this style of support stand is shown in the instant invention, it is to be distinctly understood that the invention is not limited thereto but may be variously embodied to include a variety of other features, including multiple feet. The support stand 20 allows the multifunctional flashlight 10 to be oriented or positioned in order to illuminate a specific object. In addition, at least one foot may be positioned near the rear portion of the flashlight so as to suspend the light off of a flat surface and to facilitate the pivoting and orientation of the light. The feet 24 may also prevent the flashlight from rolling over or moving when positioned or set on the ground. In one embodiment, the feet 24 are hingedly mounted to the housing allowing the feet to be fully extended or adjusted for the required orientation of the multifunctional flashlight 10.

In the preferred embodiment, the thumb switch 14 turns the light off and on, and also functions to allow the user to vary the intensity of the light emitted from the light source. In the preferred embodiment, the light output can be varied from between zero and two million candle power, however, it is to be distinctly understood that the invention is not limited to this embodiment but may be variously embodied to include a variety of other intensities and capabilities. In other embodiments, a separate on/off switch may also be included within the device. In one embodiment, the on/off switch is connected to the flashlight housing. In another embodiment, the on/off switch is also connected to the handle for ease of use.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A multi-adjustable flashlight comprising:
a housing said housing configured to hold: a light emanating source powered by an electrical current;
a first control device, said first control device configured to adjustably vary the intensity of light produced by said light emanating source;
a second control device, said second control device configured to transform incoming electrical current so as to produce and maintain an appropriate charge to said light emanating source, said appropriate charge having desired characteristics sufficient to allow said light emanating device to operate properly;
an adjustably rotatable handle connected to said housing, said adjustably rotatable handle configured to selectively rotate one hundred and eighty degrees from a first primary position to a second primary position through an infinite number of intermediate secondary positions; and
a support stand; said support stand pivotally connected to said housing.

2. The multi-adjustable flashlight of claim 1 wherein said first control device is a switch positioned within said adjustably rotatable handle.

3. The multi-adjustable flashlight of claim 2 wherein said switch is selected from the group comprised of rotational, dial, and thumb-wheel switches.

4. The multi-adjustable flashlight of claim 1 wherein said light emanating device produces a selectively adjustable output between 0 and 2 million candle power.

5. The multi-adjustable flashlight of claim 1 wherein said second control device is configured to recharge the battery of said flashlight when said flashlight is connected to an exterior alternating current power source.

6. The multi-adjustable flashlight of claim 5 wherein said second control device can simultaneously recharge the battery of said flashlight and power said flashlight.

7. The multi-adjustable flashlight of claim 1 wherein said handle further comprises a locking device for locking said device in any one of a variety of desired positions.

8. The multi-adjustable flashlight of claim 1 wherein said second control device is a direct current circuit

9. The multi-adjustable flashlight of claim 1 wherein said second control device is a rheostat.

10. The multi-adjustable flashlight of claim 1, wherein said housing further comprises at least one port said port configured to receive an adapter from an electric current source therein.

11. The multi-adjustable flashlight of claim 9, wherein said electric current source is any of a battery, AC car adapter, or AC outlet.

12. A multi-adjustable flashlight comprising:
a housing said housing said housing having a top and a bottom and configured to hold a light emanating source powered by an electrical current;
an adjustably rotatable handle connected to said housing, said adjustably rotatable handle is configured to selectively rotate one hundred and eighty degrees from a first primary position to a second primary position through an infinite number of intermediate secondary positions, said handle further comprising a switch said switch configured to adjustably vary the amount and intensity of light produced by said light emanating source from zero output to full output;
a charge maintaining device, said charge maintaining device configured to transform incoming electrical current so as to produce and maintain an appropriate charge to said light emanating source, said appropriate charge having desired characteristics sufficient to allow said light emanating device to operate properly, said charge maintaining device further configured to direct electrical current to a rechargeable battery, said rechargeable battery located within said housing; and
a support stand; said support stand pivotally connected to said housing, and configured to maintain said spotlight in a desired position and orientation.

13. The multi-adjustable flashlight of claim wherein said housing further comprises at least one port said port configured to receive an adapter from an electric current source therein, said port operatively connected to said charge maintaining device.

14. A multifunctional flashlight comprising:
a housing said housing configured to hold:
a light emanating source for providing illumination,
a power source operably connected to said light emanating source for providing power for said light emanating source,
an adjustable switch operably interconnected between said light emanating source and said power source for allowing a user to select an output level of said light emanating source,
an input regulator operably connected between said power source and said adjustable switch for maintaining a steady current and voltage to said light emanating source, at least one input port for allowing said light emanating source to be powered and said power source to be recharged;
an adjustable handle rotatably connected to said housing wherein said adjustable handle is configured to selectively rotate one hundred and eighty degrees from a first lantern style holding position to a second pistol-style hold position through and infinite number of intermediate alternative positions; and
at least one foot hingedly connected to said housing for orienting said multifunctional flashlight in a preferred position.
